(19) United States
(12) Patent Application Publication
(10) Pub. No.: US 2018/0193935 A1
(43) Pub. Date: Jul. 12, 2018

(54) Die Driver

(71) Applicant: Jason Newsome, Mayfield, KY (US)

(72) Inventor: Jason Newsome, Mayfield, KY (US)

(21) Appl. No.: 15/867,620

(22) Filed: Jan. 10, 2018

Related U.S. Application Data
(60) Provisional application No. 62/444,457, filed on Jan. 10, 2017.

(51) Int. Cl. B23G 5/20; B23G 5/04

(52) U.S. Cl. CPC B23G 5/20; B23G 5/04; B23G 2240/44; B23G 2240/36; B23G 2210/08

(57) ABSTRACT

The present invention is a plurality rods extending from a base of a die driver inserted into a plurality of openings in a threading die used to thread or re-thread a stud. A tool is inserted into a tool-receiving recess of the die driver and the driver is rotated.

### CROSS REFERENCE TO RELATED APPLICATIONS

This application claims the benefit of U.S. Provisional Application Ser. No. 62/444,457 filed by Jason Newsome on Jan. 10, 2017 and entitled “Die Driver” which is incorporated herein by reference.

### FIELD OF INVENTION

The invention relates to using an attachment to a thread repair tool in order to more easily re-thread bolts or lugs.

### BACKGROUND OF THE INVENTION

The prior art thread repair tools cannot be used on multiple applications and machines. Replacing wheel studs is costly and time consuming. Many industries have a need for thread repair including site preparation contractors, truck transportation, waste collection and disposal, construction, automotive repair, heavy equipment repair, and mining and quarry.

A die driver is a tool that works with conventional threading dies in order to rethread any type of threaded work where the original threads may be damaged. In some instances, the threading die may be used to thread a piece of metal for the first time.

One type of threading die, the hexagonal die, is well-known. One of the earliest patents on how to make a hexagonal die is U.S. Pat. No. 1,488,271. The die driver in the current invention is inserted into openings in hexagon threading dies or other-shaped threading dies to enable the user to use a wide range of readily available tools like a drill, ratchet, or original die holder with the die driver. The die driver can be used within a system or method of re-threading dies.

Most known dieholder tools grip or fit over the outside of the hexagon die. Die driver is the first to utilities the holes, sometimes also called broach or clearance openings, inside the hexagon shape. The die driver apparatus, system, and method solve the problem of the bolt, lug, screw or other threaded item being inaccessible to larger sized drills, ratchets, t-handles and other tools. The die driver also allows the threading die to be move up and down two or more rods of the die driver.

### SUMMARY OF THE INVENTION

The present invention is a die driver and a method and system for using it. A die driver uses the inside diameter of a threading die as a point of engagement in order to rotate the die in either a clockwise or counterclockwise rotation for the purpose of threading a bolt, lug, screw or other externally-threaded work. As opposed to conventional methods of holding the threading die in a holder that is in a fixed position, die driver allows the threading die to travel to and from a body along the length two or more rods. The rods engage the threading die on an inside diameter of two or more cleanout holes. Die driver can have any type of tool-receiving recess in the center of the back of the body in order to use tools to rotate it in a clockwise or counterclockwise motion. Tools with a male member may fit in the tool-receiving recess to rotate a die driver with a drill or other tool.

### BRIEF DESCRIPTION OF DRAWINGS

FIG. 1 is front view of a die driver.

FIG. 2 is a side elevational view of a die driver.

FIG. 3 is a back view of a die driver.

FIG. 4 is a perspective view of a die driver.

FIG. 5 is an exploded view of the die driver in use.

### DETAILED DESCRIPTION OF THE INVENTION

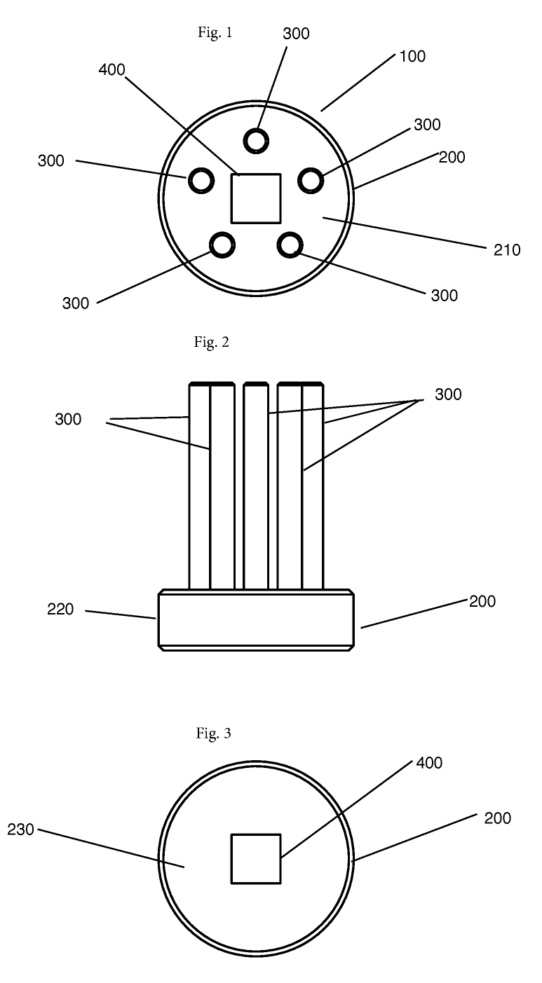

FIG. 1 is a die driver 100 having a body 200 with a front face 210. Two or more rods 300 are connected to the front face 210. The rods 300 extend perpendicularly from the front face 210. A tool-receiving recess 400 can extend throughout the thickness 220, shown in FIG. 2, of the body 200. However, the tool-receiving recess 400 need not extend all the way through to the front face 210. The thickness 220 must be enough to receive a tool that will fit in the the tool-receiving recess 400. FIG. 2 also clearly shows the rods 300 extending perpendicularly to the front face 210 of the body. The rods 300 could be cylindrical but also may be any shape including an irregular one.

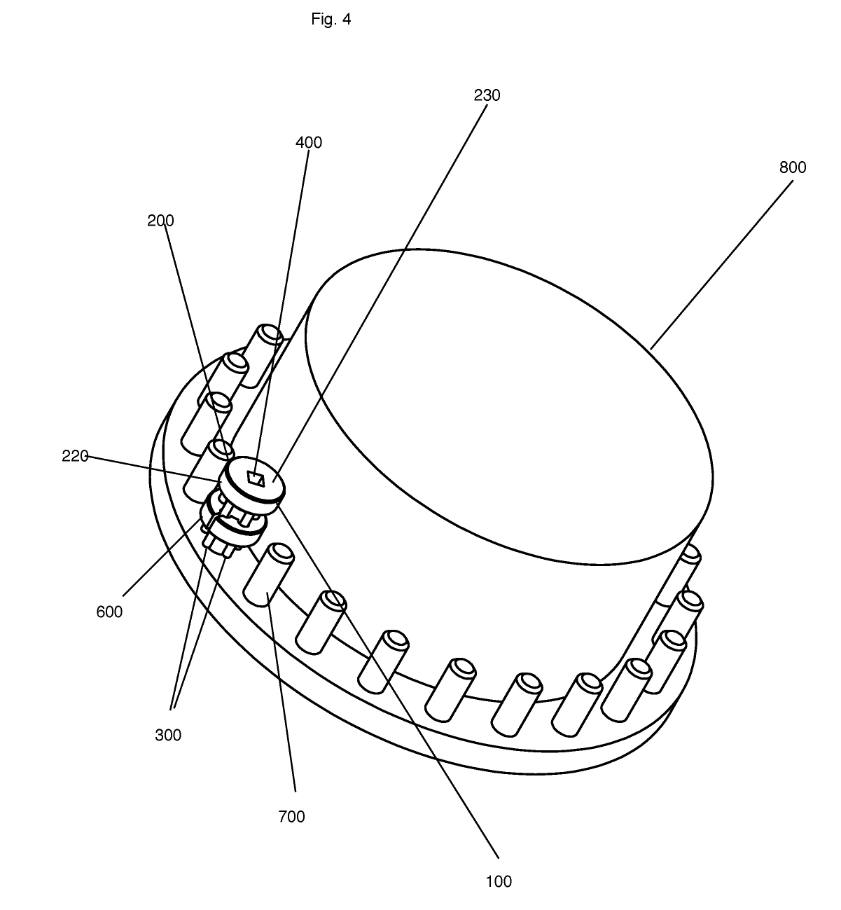

In FIG. 3, the back face 230 has a tool-receiving recess 400 in the center of the back face 230. The tool receiving-recess 400 can extend all or part of the way through the thickness 220 of the body 200.

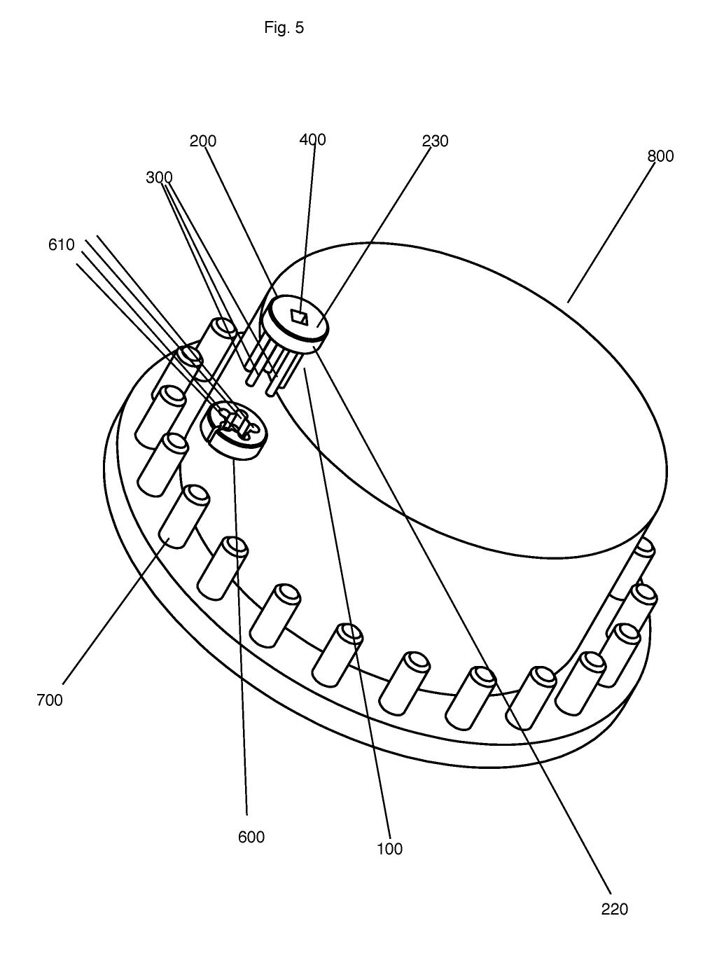

In FIG. 4, the rods 300 of the die driver 100 are placed inside a threading die 600. The threading die 600 is placed on a wheel stud 700 of a wheel hub 800. When a tool is placed inside the tool-receiving recess 400 and turned, the threading die 600 will go from body 220 to the distal end of the rods 300. As the die turns, it cuts threads into the wheel stud 700 and moves freely on the rods 300 away from the front face 210 of the body 200. To remove the die 600, use a tool inserted into the tool-receiving recess 400 to rotate the die driver 100 in an opposite direction. When the die driver 100 is rotated in the opposite direction, the die 600 will move closer to front face 230 of the body 200. Continue rotating the die driver 100 until the die 600 is removed from the stud 700.

In FIG. 5, the die driver 100 has rods 300 that can be inserted into openings 610 in the die 600. The rods 300 can be longer than the stud 700. The stud 700 is attached on a first end to a wheel hub 800.

The stud 700 can be a variety of metals. The stud 700 can be previously threaded or never threaded. The stud 700 can be attached to a wheel hub 800 or other metal object. The stud 700 could be a bolt or unattached piece of metal.

The tool-receiving recess 400 is shown a square-shaped to be used with a tool such as any type of lever, a drill, a ratchet, or t-handle. The tool-receiving recess 400 could be any angled shape including hexagon, Phillips, Allen, or torque bit.

The rods 300 can be cylindrical shaped. In another embodiment, the rods 300 might have a flat side running the length of the rod. In other embodiments, the rods 300 might have an irregular shape, which does not limit the ability of the threading die 600 to run the length of the rods 300 while the die driver is being rotated on an axis that runs from the back face 230 to the front face 210 through the center of the base.

Threading is a process of taking a never threaded stud 700 or a previously threaded stud 700 and putting replacement threads on it by replacing the grooves in the metal of the stud 700. The inside of a threading die 600 has special pattern of raised harder metal to cut into the softer metal of the stud 700 to make threads. The threads are then used to attached nuts or other parts onto the stud 700. Threads prevent the nut or other part from easily coming off the stud 700. Friction from the raised threads prevents the nut from coming off.

The threading die 600 can have an outer shape that is hexagon, round, square or any other.

I claim:

1. A method of using a threading die comprising
inserting a plurality of rods extending perpendicularly from a front face of a base of a die driver into a threading die;
inserting a tool into a tool-receiving recess of a center of a back face of the base of the die driver;
rotating the die driver causing the threading die to thread a stud; and
removing threading die.

2. The method of claim 1 wherein there are two or more rods;

3. The method of claim 1 wherein the rods have a flat side running a length of the rods.

4. A system of threading a die comprising
a die driver with a plurality of rods extending perpendicularly from a front face of a base and having a tool-receiving recess on a back face of a base; and
a threading die.

5. The method of claim 4 wherein there are two or more rods;

6. The method of claim 4 wherein the rods have a flat side running a length of the rods.

7. An apparatus comprising a die driver wherein
a plurality of rods extending perpendicularly from a front face of a base and having a tool-receiving recess in a center of a back face of the base of the die driver;

8. The method of claim 7 wherein there are two or more rods;

9. The method of claim 7 wherein the rods have a flat side running a length of the rods.
